(19) United States
(12) Patent Application Publication
(10) Pub. No.: US 2011/0244179 A1
(43) Pub. Date: Oct. 6, 2011

(54) Kit of Beach Towel and Associated Anchoring Device, Towels and Anchoring Devices

(76) Inventor: Mario George Marie-Frans Strauwen, Nieuwerkerken (BE)

(21) Appl. No.: 13/129,187

(22) PCT Filed: Nov. 12, 2009
(86) PCT No.: PCT/BE2009/000057

§ 371 Date: Jun. 15, 2011

(30) Foreign Application Priority Data
Nov. 14, 2008 (BE) 2008/0622

(51) Int. Cl. B32B 3/10; B23P 11/00

(52) U.S. Cl. 428/131; 29/428

(57) ABSTRACT

Described is a sitting means for use on a ground surface for the purpose of avoiding direct contact with the ground surface, wherein the sitting means comprises a towel (10), the towel (10) comprising at least one opening close to its edge, and at least one anchoring means (31) adapted to be arranged through the opening and to be anchored in the ground. Further described are towels, anchoring devices, sets of anchoring devices and associated methods for storing thereof.

The present invention relates to the field of towels, such as for instance beach towels.

When visiting the beach, sitting or recumbent users often do not wish to come into contact with the ground surface of the beach for reasons of comfort, hygiene or for aesthetic reasons. The ground surface can thus comprise earth, sand or rocks in a wide variety of sizes. This ground surface can be wet, can be contaminated with unhygienic material, be damp, warm or cold and so on. Certainly in the case of sandy beaches, this ground surface can moreover adhere to the user, which can bring about an uncomfortable sensation and/or irritation of the skin. The for instance adhering sand may then release elsewhere so that for instance the car or the holiday bed hereby becomes soiled. It can further also irritate the user and have an adverse effect on his or her mood.

Many users nowadays therefore use a beach towel which they spread out on the beach and on which they take up position, the beach towel here having a contact surface which comes into contact with the ground surface and an upper surface which can serve as clean sitting surface.

This use is however associated with various discomforts. The towel may thus be blown over partially or even wholly under the influence of the wind, which may bring about movement of ground, for instance sand, to the upper surface of the towel.

The movement of the user on the towel may also modify the position of the towel and can transform a previously rather flat ground surface to a surface having height differences to the extent that this irritates the user.

Height differences are often already present in the ground surface, or users form determined height differences in the ground surface beforehand which can provide a more comfortable recumbent position when the towel is arranged thereon in the correct position. The positioning or orientation of the towel may also have been carefully considered. Blowing over of the towel or movement on or walking over the towel can modify this position such that a repositioning of the towel is necessitated.

It may also be the case that a towel is not suitable for the purpose of remaining in stable position against a determined surface.

A prior art towel is typically folded up after the visit to the beach, and is often placed into a beach bag to be taken home because of its size and the possibility of undesirable unfolding of the towel were it to be carried by hand or when the user no longer has hands free. The residues of the ground surface still adhering to the towel hereby end up in the beach bag, which is undesirable.

It is an object of the present invention to provide a set of a towel and associated anchor, a towel and anchors, which resolve at least one of the above stated problems.

This is achieved with the characterizing features of claim 1.

In a first aspect of the present invention a sitting means is described for use on a ground surface for the purpose of avoiding direct contact with the ground surface, wherein the sitting means comprises a towel, the towel comprising at least one opening close to its edge, and at least one anchoring means adapted to be arranged through the opening and to be anchored in the ground. A typical ground surface can for instance be a sandy beach or a pebble beach. The towel can be manufactured from various materials such as are known to the skilled person. The towel can also have different dimensions and different shapes. The towel can preferably be defined by a single edge, but can also be defined by means of multiple edges.

In embodiments of the present invention the anchoring means comprises a pin structure (such as for instance a pin) which is adapted at its free outer end so that it can be driven into the ground (by hand or using for instance a tool such as a hammer) and is connected at its other outer end to a towel holder. This towel holder is adapted to engage or to press on the upper surface of the towel and hereby hold it against the ground surface when the anchoring means is arranged. The towel holder can also be adapted to engage over the edge of the towel, such as for instance over the outer edges of the towel, or over the edge of an opening in a towel. The underside of the towel holder can typically come into contact with the upper surface of the towel. The towel typically comprises a front and a rear surface (or contact surface).

In embodiments of the present invention the pin structure is adapted to be screwed into the ground. The pin can hereby be provided with a suitable screw structure.

In embodiments the pin structure can also be adapted to be struck into the ground or to be pressed or pushed into the ground.

In embodiments of the present invention the sitting means further comprises a socket which is adapted to be anchored in the ground (in similar manner as described for the pin structure) and which is further adapted to be coupled to the pin structure of the anchoring means.

This coupling between the anchoring means and the socket can take place by means of a screw thread connection.

In preferred embodiments the pin structure comprises on the side of the holder a screw thread or an element with screw thread onto which the holder can be fixedly screwed, the holder being provided with a complementary screw thread. In alternative embodiments the pin structure can comprise on the side of the holder a screw thread or an element with screw thread over which the holder can fit (for instance by means of an opening arranged in the holder), and a wing nut or similar structure can further be provided with which the holder can be fixed.

In embodiments of the present invention the anchoring means can comprise more than one pin structure, wherein the pin structures are connected by means of the holder.

This holder can be rigid or non-deformable, but can also be flexible, so that it can for instance be rolled up. The holder can thus comprise a strip which can be rolled up or a strip which can for instance be made of towel material. Such holders result in simplification of the storage of the anchoring means. In preferred embodiments the holder comprises towelling fabric on the surface remote from the one or more pins (its upper surface). The presence of the towelling fabric on this surface can increase the comfort of the user and simultaneously ensure an enhanced aesthetic finish.

The holder preferably allows a user of the towel to be able to take up position on the towel. The holder preferably allows stepping onto the towel from all directions. Nor preferably does the holder obstruct the view of someone situated on the towel who wishes to look in a determined direction. The holders can preferably be arranged along the edge of the towel, fixing the towel along all sides, without this impeding taking up position on the towel.

In preferred embodiments of the present invention the towel comprises more than one opening.

The towel can be polygonal (such as triangular, square, pentagonal, hexagonal, etc.) and comprise at least one opening close to at least one corner. The towel more preferably comprises at least one opening close to a plurality of corners. In preferred embodiments this towel comprises at least one opening close to each corner.

In preferred embodiments the towel is polygonal and comprises more than one opening, such as for instance two or three openings, close to at least one corner.

In embodiments the tower is polygonal and comprises close to each corner at least one or more openings (two or three openings in each corner).

In preferred embodiments the towel is rectangular and comprises two or three openings close to each corner.

In preferred embodiments the towel also comprises one or more openings along the edges of the towel remote from the corners of the towel.

In embodiments of the present invention the positions of the holes in the towel and the dimensions of the holders are adapted to each other such that the one or more holders do not have to come into contact with the ground surface when they are anchored in suitable manner in the towel.

In embodiments of the present invention the available number and the type of the holders can further also be adapted to the position of the holes in the towel and the dimensions of the holder such that the one or more holders do not have to come into contact with the ground surface when they are anchored in suitable manner through the towel.

In preferred embodiments the towel is substantially rectangular and is provided at least close to one corner (preferably close to each of its corners) with one or more protruding flaps comprising at least one opening.

In preferred embodiments of the present invention the one or more available openings are reinforced. This reinforcement can comprise a metal or plastic ring. This reinforcement can also comprise of overlocking or stitching of the edge of the opening.

In preferred embodiments the towel can comprise a covering of at least one opening, which substantially covers the opening and which is adapted to receive and at least partially cover a holder. All available openings can be provided with such a covering, particularly the openings close to the four corners of a rectangular towel. This covering can consist of towelling fabric and can thus form part of the towel. Together with the fabric of the towel around the opening to which it can be attached, the covering can form a cavity in which a holder can be at least partially received. The covering can substantially cover the opening and be adapted to at least partially receive a holder. The covering can further also comprise an incision through which can be arranged the anchoring means anchored in the ground through the opening, after which the covering can be arranged over at least a part of the holder, herein covering at least a part of the holder (or the whole holder).

In preferred embodiments of the present invention the anchoring means are permanently attached to the towel close to the openings through which arranging thereof is intended. This can for instance take place by accommodating the towel holders permanently in the cavity created by the towel, around an opening and the covering without incision as described above. The pin structures can then protrude permanently through the openings in the towel.

In preferred embodiments of the present invention the surface area (or form or cross-section) of the holes or openings present in the towel is substantially equal to the surface area of the cross-section of the associated pins (be it slightly smaller to enable passage through the opening). This is preferably the case for the cross-section of the pins close to or adjacently of the holder to which they are connected.

In embodiments of the present invention the towel comprises holes of different sizes and an anchoring device comprises pins associated therewith which also differ in cross-sectional area, so that the pins have substantially the same cross-section as the corresponding holes.

In preferred embodiments of the first aspect of the present invention the sitting means comprises a towel, wherein the towel is polygonal (for instance rectangular) and comprises at least two holes close to each of its corners, and at least one anchoring means (for instance four anchoring means in a rectangular towel) adapted to be arranged through at least two openings in the same corner of the towel and to be anchored in the ground through these at least two openings.

In preferred embodiments the anchoring means comprise at least two pin structures which are adapted at their free outer ends to enable being driven into the ground and are connected at their other outer end to a towel holder which is adapted to engage on the upper surface of the towel and hereby hold it against the ground surface when the anchoring means has been arranged.

A second aspect of the present invention comprises a towel which comprises at least one opening adapted to anchor this towel in the ground by means of an anchoring means. In embodiments the towel is polygonal and comprises at least one opening close to each corner. The towel can be substantially rectangular and comprise two or three openings close to each opening.

In preferred embodiments the towel also comprises openings along the edges of the towel, remote from the corners.

In preferred embodiments the towel is substantially polygonal (for instance rectangular), but is provided close to at least one corner with one or more protruding flaps comprising at least one opening or comprising at least one opening in each case.

In preferred embodiments at least one of the openings is reinforced.

In preferred embodiments the towel comprises on at least one side at least one covering of at least one opening which substantially covers the opening and which is adapted to house a holder after it has been arranged in the opening. This covering can be made from towelling fabric and can be integrated with the towel. This covering can for instance comprise in the centre an incision which allows the anchoring means to anchor in the ground through the towel, after which the holder (or at least part of the holder) can be covered using the covering.

In preferred embodiments the towel can comprise permanently attached anchoring means close to the openings through which arranging thereof is intended. These permanently present anchoring means can be fixed to the towel by means of connecting means, such as for instance a fabric or plastic loop which connects the corners of the towel to the anchoring means. The anchoring means can also be partially received in the cavity created by the fabric around the opening and the covering of the opening, which for instance fixes the towel holder in the towel. The pin structure can protrude through the opening in the towel in the direction of the contact surface of the towel.

A third aspect of the present invention comprises an anchoring device for a towel comprising at least one pin structure which is adapted at its free outer end to be arranged through an opening in the towel and to enable being driven into the ground (under the towel), and is connected at its other outer end to a towel holder adapted to engage on (or to press or come into contact with) the upper surface of the towel and hereby hold it against the ground surface.

The pin structure can be adapted to be screwed into the ground. The pin structure can be adapted to be struck or pushed into the ground.

In preferred embodiments of the present invention the anchoring device further comprises a socket which is adapted to be anchored in the ground and which is further adapted to be coupled to the pin structure. The coupling of the anchoring means to the socket can take place by means of a screw connection.

In preferred embodiments the pin structure comprises on the side of the holder a screw thread or element with screw thread onto which the holder can be tightened, the holder for instance being provided with a complementary screw thread.

In preferred embodiments the pin structure comprises on the side of the holder a screw thread or element with screw thread over which the holder can fit (for instance by means of a hole in the holder) and which further comprises a wing nut (or similar structure) in which the holder can be fixed.

In preferred embodiments the anchoring means comprises more than one pin structure, and these pin structures are connected by means of the holder.

In preferred embodiments the holder is substantially flexible or can be rolled up. In other embodiments this holder can be substantially rigid or non-deformable. In preferred embodiments the holder can consist of towelling fabric or can comprise towelling fabric on the surface remote from the one or more pins (the upper surface).

Described in a fourth aspect of the present invention is a set of anchoring devices as described for the third aspect of the present invention, which further comprises at least one metal or plastic annular structure which is manufactured for the purpose of being pressed through a towel, here creating an opening in the towel, and for further engaging round the edge of the opening so as to thus strengthen it.

A fifth aspect of the present invention relates to a method for storing a towel (for instance according to the second aspect of the present invention), for instance a towel which comprises at least two holes, comprising of folding the towel such that at least two openings of the towel are aligned and of arranging an engaging means through the aligned openings. In preferred embodiments the towel is polygonal and comprises at least one opening close to each corner. In preferred embodiments at least one opening of each corner of the polygonal towel is aligned. In preferred embodiments the towel is rectangular, although other shapes are not precluded.

In preferred embodiments all openings of the towel can be aligned. In preferred embodiments four openings can be aligned.

In preferred embodiments the openings can be aligned in a manner such that the front and rear sides of the towel do not come into direct contact with each other after arranging of the engaging means through the openings.

Described in a sixth aspect of the present invention is a sitting means which comprises at least two towels, the towels each comprising at least two holes, and which comprises at least one anchoring means adapted to be arranged through the openings of the towels and to be anchored in the ground, wherein the number, the shape and dimensions of the towels, the number and the positions of the holes in these towels and the number and dimensions of the at least one anchoring means are predetermined to enable forming of a predefined pattern on the ground surface with the towels.

The sitting means preferably comprises a plurality of towels, a plurality of holes in each of these towels and a plurality of anchoring means in order to define and fix the predetermined pattern on the ground surface.

In preferred embodiments the predefined pattern comprises at least one overlap zone between at least two different towels.

In preferred embodiments the anchoring means do not touch the ground surface when they are arranged according to the predetermined pattern.

In preferred embodiments the anchoring means do not protrude above the surface of the respective towels when arranged.

In preferred embodiments each of the anchoring means comprises at least two pin structures which are adapted at their free outer ends to enable being driven into the ground and which are connected at their other outer ends to a towel holder adapted to be able to rest on the upper surface of the one or more towels, so holding these against the ground surface.

The pins of such anchoring means are preferably adapted to be struck into the ground by exerting pressure on the holder.

In preferred embodiments the holder of at least one of the anchoring means can be rolled up. In preferred embodiments the holders of all anchoring means can be rolled up.

In preferred embodiments the holder of at least one anchoring means is rigid or non-deformable. In preferred embodiments the holders of all anchoring means are rigid or non-deformable.

In preferred embodiments the towels are polygonal and comprise at least one opening close to each corner.

In preferred embodiments towels are rectangular and comprise one, two or three openings close to each corner. In preferred embodiments towels are rectangular and comprise one opening close to each corner. In preferred embodiments towels are rectangular and comprise two openings close to each corner. In preferred embodiments towels are rectangular and comprise three openings close to each corner.

In preferred embodiments the towels further comprise openings along the edges of the towel, remote from the corners of the towel.

In preferred embodiments the towels further comprise openings in the interior of the towel, remote from the corners and from the edges of the towel.

Described in a seventh aspect of the present invention is a method for storing at least two towels together, wherein each of the towels for storing comprises at least one opening, comprising of aligning at least one opening of each of the towels and arranging an engaging means through the aligned openings.

In preferred embodiments each of the towels comprises a plurality of holes and at least two of the plurality of holes of each of the towels are aligned.

In preferred embodiments two towels of the same form can be stored together by bringing the front sides of the respective towels into mutual contact, wherein the holes of the first towel are aligned with the holes in the second towel.

In preferred embodiments in which two towels of the same form are stored together, at least two pairs of aligned holes of the two towels are further aligned.

In preferred embodiments in which two towels of the same form are stored together the two towels are rectangular and comprise at least one hole in each of the corners, and four pairs of aligned holes of the two towels are further aligned.

In preferred embodiments the outer surface of the stored towels is formed, after storing, by a rear side of only one of the towels.

Described in an eighth aspect of the present invention is a method for developing a sitting means according to the sixth aspect, comprising of;
predetermining a geometry of the sitting means;
determining a number of towels, each of these towels having a predetermined form, which can together form the predetermined geometry when placed on a ground surface in a predetermined manner;
providing a predetermined number of openings at a predetermined number of locations in the different towels and providing a predetermined number of anchors of predetermined types, in a manner such that the anchors can anchor the different towels in predetermined manner relative to the ground surface in the predetermined geometry, through the openings in the towels.

Further aspects of the present invention are described in the dependent claims. The features of the dependent claims, features of any of the dependent claims and any of the features of other dependent claims can be combined and deemed appropriate by the skilled person, and not only in the specific combinations as defined by the claims.

The accompanying drawings are used to illustrate embodiments of the present invention.

Reference symbols are chosen such that they are the same for similar or the same elements or features in different figures or drawings.

The above stated and other advantageous features and objects of the invention will become more apparent and the invention better understood as a result of the following detailed description when read in combination with the respective drawings.

The description of the aspects of the present invention is given by means of specific embodiments and with reference to, but not limited to, specific drawings. The shown figures are only schematic and must be deemed as being non-limitative. Specific elements or features can for instance be represented out of proportion or scale in relation to other elements.

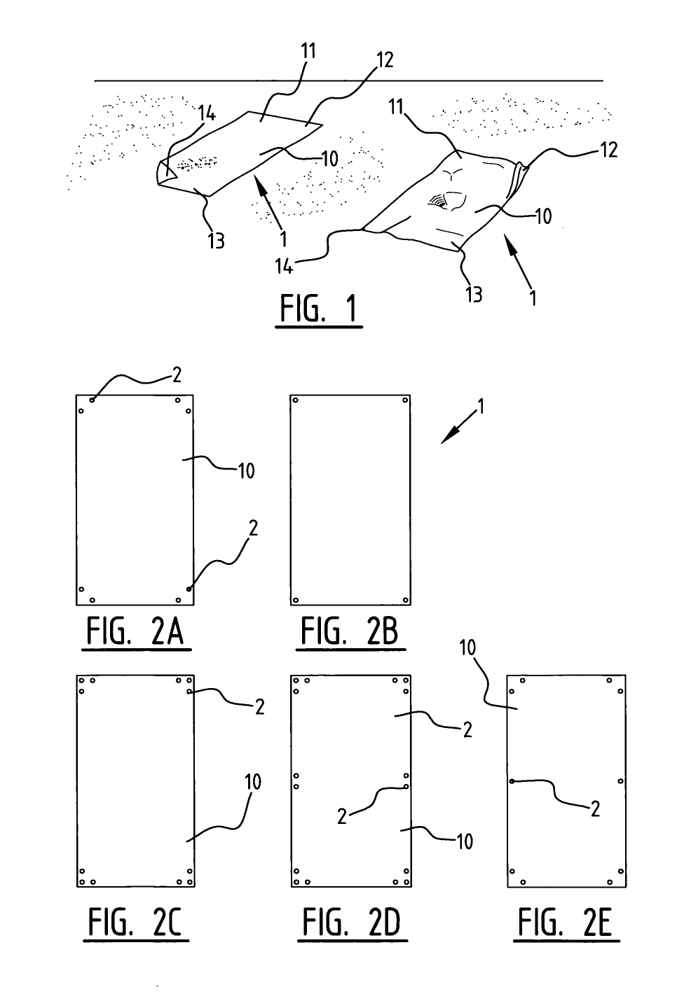

FIG. 1 shows a typical prior art situation. Towel 1 lies on a ground surface of the beach, for instance a sandy beach or a pebble beach, and here defines a towel surface 10. Like most towels, the shown towel is of rectangular shape and has four right angles 11, 12, 13, 14. This towel typically lies with its underside (or lower surface) on the ground surface and has an upper side (or upper surface) which remains clear of the ground surface. The upper side hereby remains clean and provides a comfortable location for the user. However, when there is wind and/or people walk over the towel or displace or move thereon, the position of the towel can change. It can for instance also be blown upward such that a part (for instance a corner of the towel) folds over. This can result in ground material still getting onto the towel, which may reduce user comfort. This can also further reduce the available surface area of the towel. It can also change the position of the towel, which is often undesirable. The towel often has a determined position. A towel is sometimes arranged in the ground and must be arranged in a well-considered position. The wind or other influences can change this position such that the towel has to be repositioned.

FIGS. 2A-2E show towels according to embodiments of the present invention, although many other embodiments are possible. This towel is preferably polygonal, in this case rectangular, but can also have other shapes. The towel does not necessarily have to comprise corners and can also comprise a periphery with curves, or for instance a single corner and a curve which mutually connects the legs of the corner, or for instance two corners, the legs of which are mutually connected by means of curves. The dimensions of a towel can for instance be 200 cm×100 cm, or 200 cm×130 cm, or 200 cm×200 cm, although any dimensions are possible in principle. This towel 1 can comprise one or more holes 2 in each of its corners. Each corner can thus be provided with one hole (see for instance FIG. 2B), two holes close to each corner (see for instance FIG. 2A, 2E), or with three holes close to each corner (see for instance FIG. 2C and 2D). Holes can further also be provided along the sides of the towel, remote from the corners (see for instance FIG. 2D, 2E). In a particular embodiment each corner can be provided with two holes close to the corner, each hole of which is arranged along the sides define the associated corner. There can also be three holes, wherein a third hole is also arranged in addition to the two above defined holes which is even closer to the corner than the two other holes, such that the three holes together form two legs which form a right angle to each other.

The holes can for instance be circular but can also take other forms, such as for instance triangular, quadrangular (for instance square, rectangular or rhombic), polygonal (optionally regular), elliptic and so on. The circular holes can have a diameter d of about 1 cm, about 1.5 cm, about 2 cm, although other values are also possible.

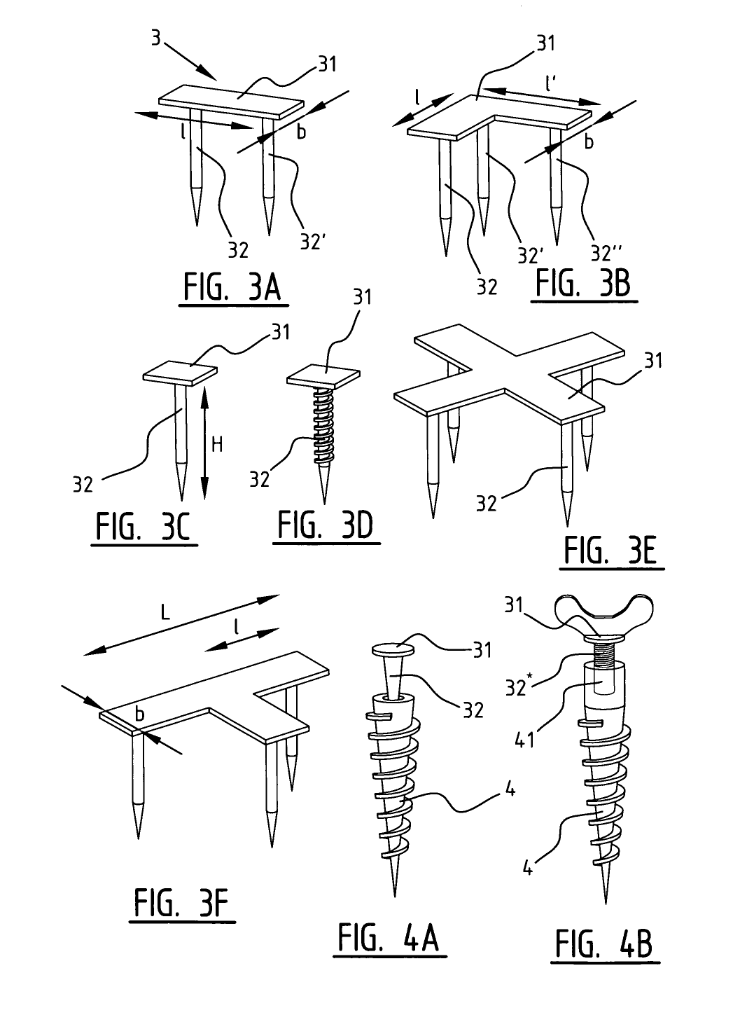

FIGS. 3A-3F and FIG. 14 show anchoring devices or anchoring means according to the present invention. These anchoring devices can comprise one or more pins which are adapted to co-act with the holes in the towel as defined for instance in FIGS. 2A-2E. FIG. 3C shows an anchor 3 comprising a pin 32 and towel holder 31. The towel holder is fixed relative to the pin and provides a surface which can hold the towel in place when the pin is arranged through the hole in the towel. This holder further preferably has a form which further allows force to be exerted on this holder along the longitudinal direction of the pin in order to drive this pin into the ground. FIG. 3D shows a further anchor according to embodiments of the present invention, which is similar to the embodiment of FIG. 3A but which further comprises a screw structure along the pin, in other words wherein the pin actually has a structure which is adapted to be screwed into a determined ground, such as for instance a sandy ground surface. In this embodiment holder 31 can be further adapted to facilitate grasping with a hand when a rotating movement of the anchor must be performed in order to screw this anchor into the ground. The holder is here also adapted to hold the towel in place when the anchor is arranged in suitable manner through the towel and anchored into the ground. FIG. 3A shows a further embodiment in which the anchor comprises more than one pin (32, 32′), both of which are connected to each other by means of holder 31. This holder can thus also function as a connecting piece between these pins. This holder can further be adapted to allow pressure to be exerted in the direction of the pin(s) in order to thus drive the pin(s) into the ground. FIG. 3B shows a further variant of the anchor wherein three pins 32, 32′, 32″ are connected by means of a holder 31. FIG. 3E shows a further embodiment of the present invention wherein a cross-shaped holder 31 is provided at the outer end of each of the crossed arms with a pin 32. The holder can be used for instance to position two adjacently lying towels relative to each other. Other anchors can also be provided which are adapted to engage in openings of different towels which have been developed for positioning in a predetermined manner relative to each other. FIG. 3F shows a further embodiment wherein the holder is substantially T-shaped, and wherein the anchoring device comprises a pin 32 close to each of the outer ends of the “T”. The length H of the one or more pins can for instance be about 5 cm, 6 cm, 7 cm, 8 cm, 9 cm, more preferably about 10 cm, about 11 cm, 12 cm, 13 cm, 14 cm, about 15 cm, although shorter and longer pins are not precluded and the appropriate length can vary as a function of for instance the relevant ground surface. The width b of the holders can be for instance about 2 cm, about 3 cm or about 4 cm, although other smaller or greater widths are also possible. The length l (optionally of a leg) of the holder can be about 8 cm, 9 cm, 10 cm, 11 cm, 12 cm, although other lengths are also possible, as can be appreciated by a skilled person. Different legs can also comprise different lengths, as illustrated for instance in FIG. 3B by lengths l and l′. l is preferably equal to l′. The embodiments of the “T” type can for instance comprise a length L of the “horizontal” part of about 15 cm, 16 cm, 17 cm, 18 cm, 19 cm, 20 cm, although greater and smaller values are also possible. The “vertical” part of the T, which lies perpendicularly of the “horizontal” part and connects thereto close to the centre thereof, can for instance have a length of 5 cm, 6 cm, 7 cm, 8 cm, 9 cm, 10 cm, although other values are also possible.

FIG. 14 shows a further embodiment wherein the anchoring device comprises an L-shaped holder which comprises two pins placed at the outer ends of the legs of the L. This embodiment differs from the embodiment shown in FIG. 3B in that the pin close to the right angle defined by the L-shape is not present. Note that the holder can be adapted to extend during use as far as a corner of the towel without comprising a pin in this corner (in respect of the towel without a hole in the corner).

FIGS. 4A and 4B show further embodiments of the present invention, wherein the pin can correspond to a pin as shown in FIGS. 3A, B, C, E and F, but wherein these anchors co-act with a socket 4 which is adapted for driving into the ground on one side and which comprises on the other side a coupling means for coupling to the anchors as described above (see for instance FIG. 4A). In this embodiment anchor 3 can once again comprise a holder 31 which co-acts with a pin 32, which is however provided with a screw thread (32*). This screw thread can then co-act with a complementary screw thread provided in socket (41) (see for instance FIG. 4B). Holder 31 can optionally be provided with a structure which facilitates tightening of pin 32 into socket 4, such as for instance two wings.

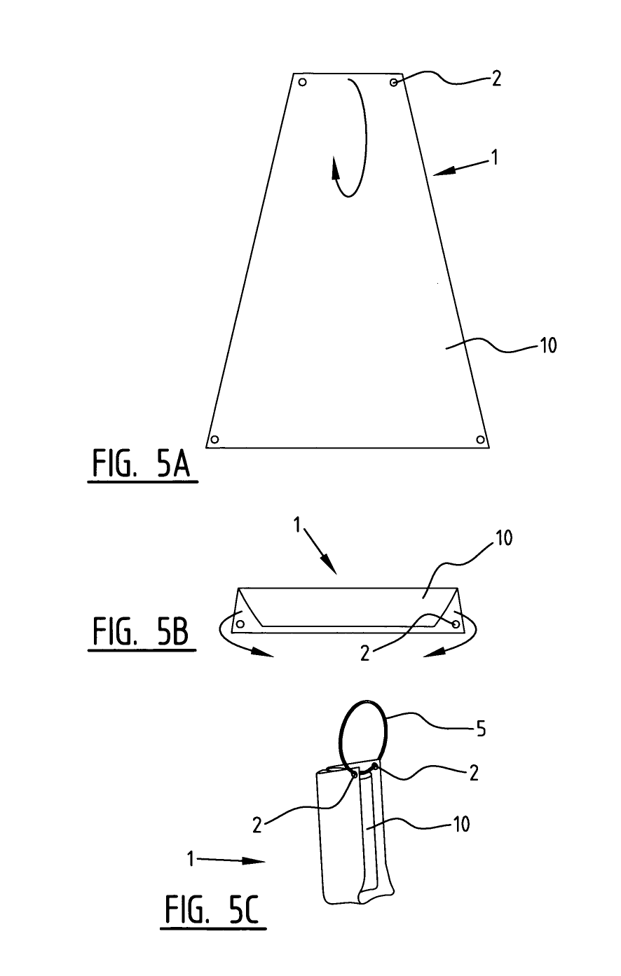

FIGS. 5A to 5C show further embodiments of the present invention, wherein a towel comprises one hole in each of the four corners, but wherein the towel takes the form of a trapezium, but with two opposite sides of equal length. A specifically considered choice of the shape of the towel can allow storing of this towel in simple manner. A trapezoidal towel can for instance be easily rolled up such that two openings remain free on the outer end of the rolled-up towel. The towel can then be easily stored or carried by inserting an engaging means through these free openings 2 after the towel has for instance first been folded together and the openings aligned. This engaging means can for instance be a ring which can then be attached afterward to for instance a trouser buckle or rucksack.

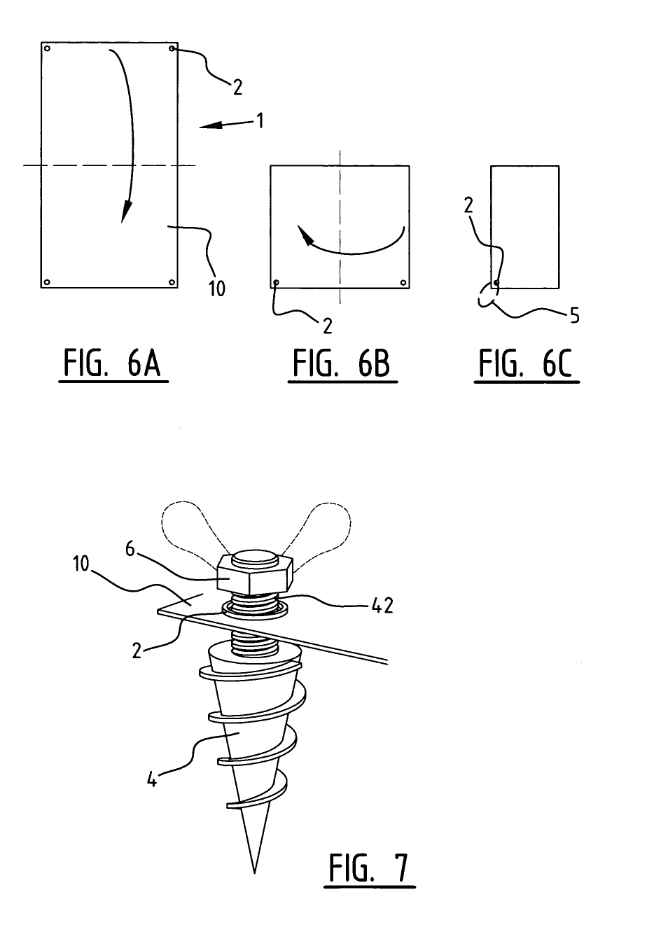

FIGS. 6A to 6C show a further embodiment of the present invention which illustrates a method for storing a towel according to embodiments of the present invention. This shown towel is of the rectangular type and comprises one opening in each of the four corners (FIG. 6A). By folding the towel in two in lengthwise direction the holes can be aligned two by two one over the other (FIG. 6B). Further folding of the towel can ensure that the four holes are aligned in one corner of the folded towel (FIG. 6C). Through these aligned holes can then be arranged an engaging means, such as for instance a ring or cord, which can facilitate carrying of the towel.

FIG. 7 shows a further embodiment of anchors according to the present invention. Pin 32 here comprises its freestanding part at the top, and on the other side a part adapted to be driven into the ground, a screw thread 321, or an element with screw thread which can couple to a modified nut such as a wing nut. Over the screw thread can then be arranged a holder (not shown) which is in turn tensioned fixedly by means of the structure of the nut type (for instance the wing nut), herein pressing downward and holding the towel fast. The nut structure or the structure of screw thread type 6 can further be integrated with holder 31 (in other words the structure can be part of the holder or form the holder) such that the holder itself can be tightened over the pin provided with thread or element to which the pin is connected.

FIG. 8 shows a further embodiment wherein the towel has a substantially rectangular periphery, but wherein a further flap 101 is provided at each corner which protrudes from this rectangle. Each of these flaps can be provided with an opening which allows fixing of the towel relative to the ground surface.

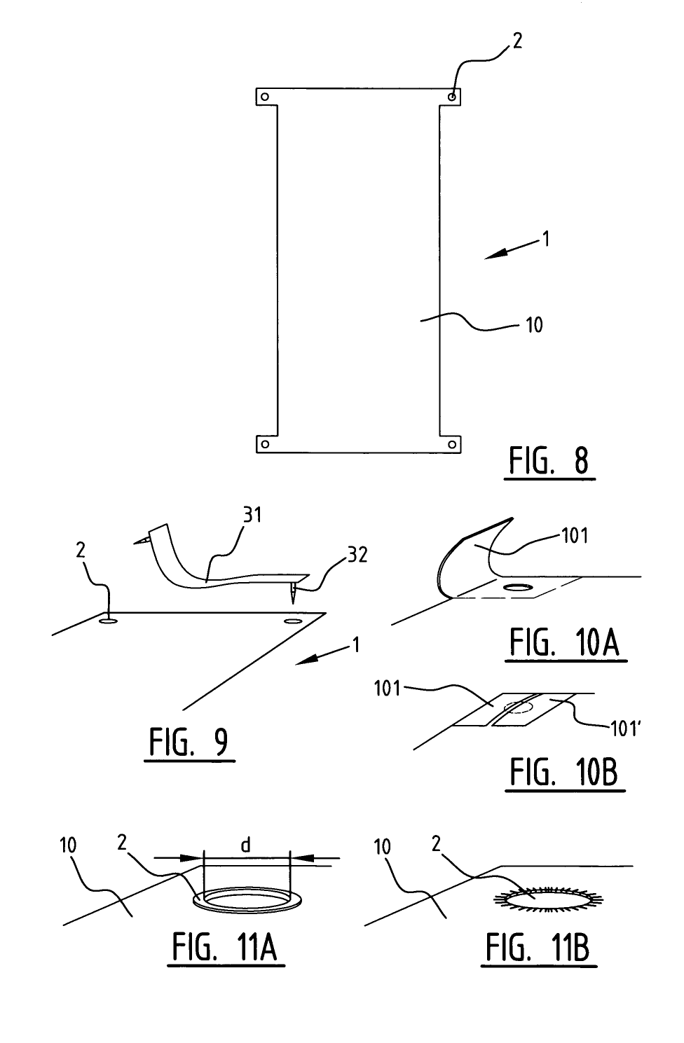

FIG. 9 describes a further embodiment of the present invention. In embodiments the anchors or anchoring means engage in openings lying substantially close to the same corner of the towel. This is not strictly essential however. In this figure an anchoring means is shown which is adapted to engage in two different corners of a rectangular towel. This anchoring means allows the towel to be held fixedly over a larger area. Holder 31 can here be rigid or non-deformable, or flexible. When a roll-up tape is for instance used as holder, it can be easily stored away. This holder can further also be rigid or non-deformable such that a stronger securing of the towel to the ground surface can be obtained. This holder can for instance also consist of a strip of towelling fabric. This holder can for instance also consist of a rigid or non-deformable material. The holder can moreover be covered on its upper side facing away from the pin with a material which increases comfort, such as for instance towelling fabric. The anchors and anchoring devices according to the present invention can be produced by means of injection moulding. They can consequently consist of one element comprising towel holder and pin structure. When a flexible holder is chosen, a pin, which is for instance produced by means of the injection moulding technique, can be connected to the holder in other manner as known to the skilled person. In such embodiments the pin preferably has on its upper surface a form adapted for the purpose of simplifying exertion of force by hand or with a tool such as a hammer.

FIGS. 10A and 10B show embodiments of the present invention, wherein the towel is further provided around the opening with a covering. This covering (101, 101′) can for instance be provided in towelling fabric and can conceal the opening from view. This covering can further comprise an opening, such as for instance an incision, particularly when this covering is permanent (is for instance fixed above the opening). This covering can for instance comprise two mutually adjacent and abutting pieces of fabric which together cover the opening (FIG. 10B, 101, 101′). The covering can be made from one piece when the anchoring means are fixed to the towel, and so form an integrated part thereof. When however the covering can be opened by means of for instance the incision in the towelling fabric (or if two mutually adjacent pieces of fabric are present (101,101′)), the anchor can be driven into the ground through the opening, after which the anchor holds (the corner of) the towel against the ground surface. The one, two or more flaps (101,101′) or the covering can then once again be arranged on top of the holder such that the holder is also concealed from view. The covering of the holder can also result in a safer use of the anchoring means. The anchoring devices, which in some embodiments are hard, could injure the user or reduce the comfort of the user if they are not shielded by means of a (softer) covering. Note that in the embodiments shown in FIG. 10A the flaps 101 which can be comprised in the towel do not themselves comprise any holes but are adapted and positioned to cover a nearby opening in the towel.

FIGS. 11A and 11B show embodiments of the present invention, wherein the one or more holes or openings in the towel are reinforced. In FIG. 11A a reinforcement is realized by means of a ring manufactured from metal or plastic. In determined embodiments this ring can be arranged in a towel which initially comprises no holes. The ring can be pressed through the towel, herein creating an opening in the towel, and can then be further deformed in order to further strengthen the edge of the opening. In determined embodiments, after pressing out of the opening in the towel, the ring can be further folded shut around the edge of the opening such that the ring has a first part adjoining the front side of the towel and a second part adjoining the rear side of the towel which are connected to each other via a part of the ring situated along the side of the opening. FIG. 11B shows another form of reinforcement according to embodiments of the present invention. This reinforcement can take place by arranging an overlocking or stitching over the edge of the opening. The openings can also be strengthened by being covered with a piece of fabric, this piece of fabric then being sewn fixedly around the opening.

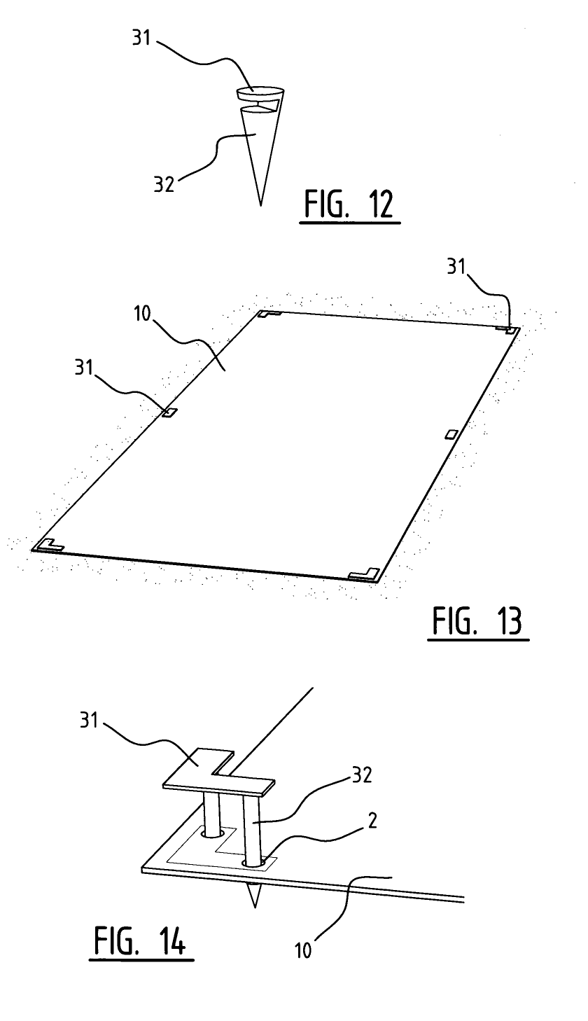

FIG. 12 shows a further embodiment according to a further aspect of the present invention, which comprises an anchoring device for a towel lying on a ground surface, comprising at least one pin structure which is adapted at its free outer end to be arranged in the ground under the towel (and can for instance be driven therein) (preferably close to the edge of the towel or in an opening in the towel according to embodiments of the present invention) and comprising at its other outer end a towel holder (which is for instance connected thereto) which is adapted to engage on the edge of the towel in order to thereby fix the towel against the ground surface. This towel holder can for instance comprise a groove or channel in which a towel (according to the prior art or according to embodiments of the present invention) can slide so as to be thus held fast. In accordance with the embodiment, it can be the edge of the towel or the edge of the opening in the towel which slides into the groove or channel. The towel can be tensioned by further orienting this anchoring device in suitable manner and/or arranging thereof in suitable manner in the ground through the openings in the towel (wherein the edge of the opening in the towel is arranged in the groove or channel). This is for instance possible by arranging for example four such anchoring devices in holes close to the for example four respective corners of the towel, wherein the channels or grooves in the towel holders are directed outward, for instance in a direction away from the interior of the towel.

In other similar embodiments the towel holder can comprise one or more clips which are adapted to clamp the towel (for instance the edge thereof or the edge of an opening in the towel). An example of suitable clips is for instance a clip of the clothes-peg type. The clip can comprise an upper and a lower jaw mounted pivotally relative to the other by means of a shared pivot mutually connecting the lower and upper jaw, and can further comprise a spring means adapted to push or pull the jaws toward each other when they are moved apart. Both jaws can for instance be provided with respective parts which extend along the other side of the pivot but which are connected to the respective jaws, the parts being adapted and arranged, when they are moved toward each other around the pivot, to move the jaws away from each other so as to thus form an opening between the jaws in which for instance the edge of the towel can be arranged. When the parts are released, the jaws are preferably driven toward each other by means of the spring means. Other clips can also be used, as will be appreciated by the skilled person.

FIGS. 13 and 14 show embodiments of the present invention. The towel can be rectangular and can comprise two openings close to its four corners, while it can further comprise one opening along each of the sides in the lengthwise direction of the towel (preferably halfway along the length of the towel). L-shaped anchoring means can be used close to the corners, comprising an L-shaped holder and two pins, each positioned at one of the outer ends of the two legs of the “L” (see for instance FIG. 14). Anchoring means according to embodiments of the present invention as shown in for instance FIG. 3C (be it with square or rectangular elongate holder) can further be used to fix the sides of the towel.

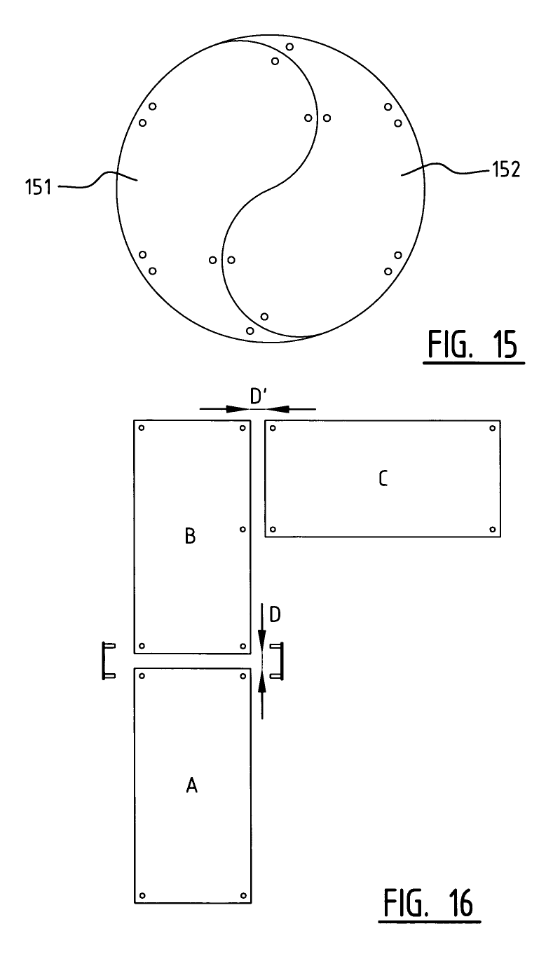

A further aspect of the present invention is described in FIG. 15. Two towels (151, 152) having a specific shape so that they can together form a yin-yang symbol are provided with holes around their periphery. The sitting means as shown is preferably further provided with eight anchoring means consisting of an elongate holder connecting the non-free outer ends of two pins at a time, and wherein the free outer ends of the pins can be arranged through the pairs of nearby holes. Some of these pairs of holes are arranged along and in the edge of one of the towels. Other pairs of holes are formed by positioning the towels in a predetermined manner relative to each other such that for instance one hole of a first towel is placed adjacently of one hole of a second towel, wherein a holder can be arranged through these two holes, and wherein this holder extends over portions of both towels. In this embodiment eight similar anchoring means could for instance be provided in order to fix the whole sitting means comprising the two towels into the ground.

A further embodiment is described in FIG. 16, wherein three towels are arranged in the form of an “L” in a manner such that there is a first distance D between a first (A) and a second (B) towel, and so that there is a distance D′ between a second and a third (C) towel. The anchoring means preferably also comprise two pins in each case. Two different pairs of identical anchoring means can for instance be provided, wherein the distance between the two pins is different for the two pairs. By making a suitable choice of the positions of the holes, the shape of the towels and the distance between the two pins of the anchoring means, it is preferably possible to ensure that the two towels touch each other (D=0).

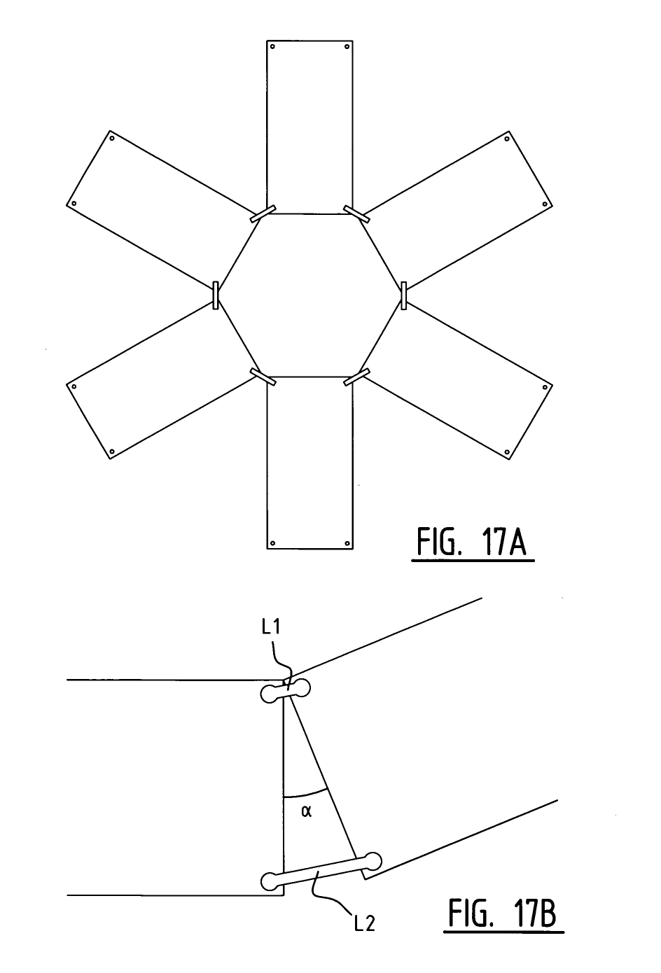

FIG. 17A shows a further embodiment wherein six towels, which are of the same form and comprise in each case an opening in two adjoining corners, are positioned relative to each other so as to thus form a “flower” structure wherein six anchors engage over two holes at a time. One of these holes is in a first towel and the other hole is in a second towel.

FIG. 17B illustrates that, for instance by varying the distance between the two pins of the anchoring means (for instance L1<L2), it is possible to provide for an angle a between two rectangular towels of the same form arranged adjacently of each other on the ground surface, wherein for instance each of these towels comprises one opening in each of its relevant corners. At the top they touch each other and at the bottom an opening has been created between the sides of the towels laid adjacently of each other.

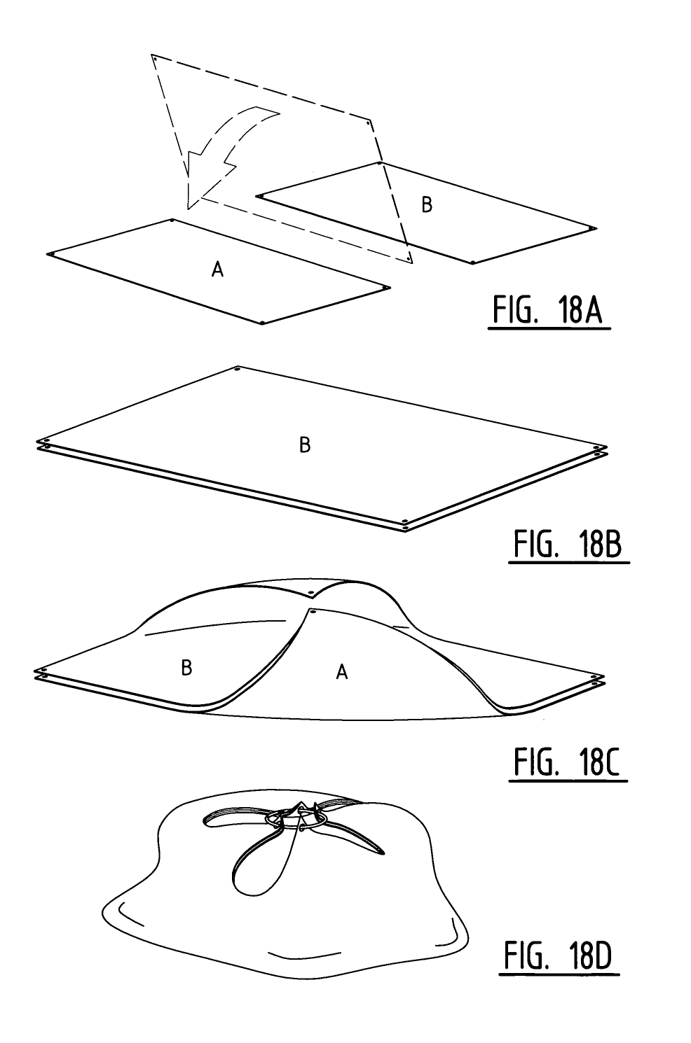

FIG. 18 illustrates a further aspect of the present invention, wherein a method is described which allows at least two towels to be stored away together. The front side of a first towel (A) is brought into contact with the front side of a second towel (B). The front side can here be deemed as the side of the towel which does not come into contact with the ground surface. These towels are of the same form and have openings at corresponding locations. When the second towel is reversed onto the first towel, the respective holes come to lie over each other and are aligned so that in this case four pairs of aligned holes are obtained. These four pairs of aligned holes can in turn be aligned again, as shown in a possible first step in FIG. 18C or at a later stage in FIG. 18D. An engaging means can then be arranged through these eight holes in order to thus complete storage. Note that the rear side of one of the towels, for instance the rear side of the first towel (A), is eventually situated on the outside of the stored package.

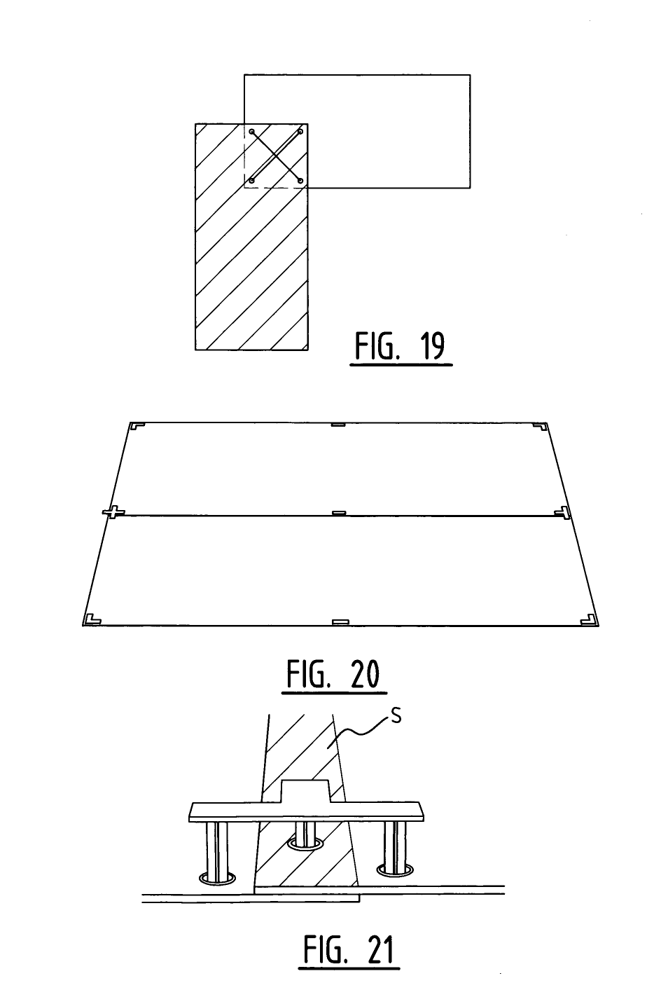

FIG. 19 describes a further embodiment wherein an anchor as described in FIG. 3E can be used to fix two towels relative to each other and the ground surface, wherein the two towels have a predetermined overlap, by further arranging holes at suitable positions in the towels. Four corresponding holes have here been arranged in both towels, three of which have been arranged along the edge of each towel and wherein a fourth is arranged away from the edge toward the interior of the towel.

FIG. 20 describes a further embodiment wherein two towels of the same form are placed adjacently of each other in lengthwise direction and wherein the side of these towels overlap slightly, so that a strip-like overlap (S) (see FIG. 21) is obtained between the two towels. This strip-like overlap has for instance a constant width. The rectangular towels are provided with holes close to their four corners, and for instance also along the edges in the lengthwise direction of the towel. The holes are arranged at predetermined locations so that, when laid down overlapping, a number of these holes correspond and are aligned so that predetermined corresponding anchors can be arranged in the ground through the overlapping holes. As a result these anchors can be used to fix two or more towels simultaneously relative to the ground surface. In the specific example of FIG. 20 the two towels are laid adjacently of each other with an overlap of the width of the overlap strip of for instance several to ten centimetres, and a number of holes of the relevant towels are aligned in the zone of overlap.

FIG. 21 illustrates the use of a T-shaped anchor in the embodiment of FIG. 20, for instance as illustrated in FIG. 3F, in order to fix two towels relative to the ground surface close to the zone of overlap. The anchor of FIG. 3E can also be used for this purpose. Anchors as illustrated in FIGS. 3A and 3B, as well as other anchors, can further also be used to fix together the two or more towels relative to the ground surface.

In the description of determined embodiments according to the present invention different features have sometimes been grouped in a single embodiment, figure or description thereof, with the object of contributing toward the understanding of one or more of the different inventive steps. This may not be interpreted as if all features of the group must necessarily be present to resolve a specific problem. Inventive aspects are not to be found in all features of such a group of features present in the description of a specific embodiment.

While some embodiments described herein comprise some, but not other, features included in other embodiments, combinations or features of different embodiments are understood to be within the scope of the invention, and to form different embodiments, as will be understood by the skilled person.

While the principles of the invention have been described above with reference to specific embodiments, it must be clearly understood that this description has been given only by way of example, and is not limitative for the scope of protection defined by the appended claims.

1.-48. (canceled)

49. A sitting means comprising at least two towels, the towels each comprising at least two holes, the sitting means further comprising at least one anchoring means adapted to be arranged through the openings of the towels and to be anchored in the ground, wherein the number, the shape and dimensions of the towels, the number and the positions of the holes in these towels and the number and dimensions of the at least one anchoring means are predetermined to enable forming of a predefined pattern on the ground surface with the towels.

50. The sitting means according to claim 49, comprising a plurality of towels, a plurality of holes in each of these towels and a plurality of anchoring means in order to define and fix the predetermined pattern on the ground surface.

51. The sitting means according to claim 49, wherein said predefined pattern comprises at least one overlap zone between at least two different towels.

52. The sitting means according to claim 49, wherein the anchoring means do not touch the ground surface when they are arranged according to the predetermined pattern.

53. The sitting means according to claim 49, wherein the anchoring means do not protrude above the surface of the respective, towels when arranged.

54. The sitting means according to claim 49, wherein each of the anchoring means comprises at least two pin structures which are adapted at their free outer ends to enable being driven into the. ground and which are connected at their other outer ends to a towel holder adapted to be able to rest on the upper surface of the one or more towels, so holding these against the ground surface.

55. The sitting means according to claim 54, wherein the pins of such anchoring means are preferably adapted to be struck into the ground by exerting pressure on the holder.

56. The sitting means according to claim 54, wherein the holder of at least one of the anchoring means can be rolled up.

57. The sitting means according to claim 54, wherein the anchoring means is rigid or non-deformable.

58. The sitting means according to claim 49, wherein the towels are polygonal and comprise at least one opening close to each corner.

59. The sitting means according to claim 49, wherein the towels further comprise openings along the edges of the towel, remote from the corners of the towel.

60. The sitting means according to claim 49, wherein the towels further comprise openings in the interior of the towel, remote from the corners and from the edges of the towel.

61. A method for developing a sitting means according to claim 1, comprising of;
predetermining a, geometry of the sitting means;
determining a number of towels, each of these towels having a predetermined form, which can together form the predetermined geometry when placed on a ground surface in a predetermined manner;
providing a predetermined number of openings at a predetermined number of locations in the different towels and providing a predetermined number of anchors of predetermined types, in a manner such that the anchors can anchor the different towels in predetermined manner relative to the ground surface in the predetermined geometry, through the openings in the towels.

62. A method for storing a towel, said towel being polygonal and comprising at least one opening close to each corner, comprising of folding the towel such that at least two openings of the towel are aligned, and arranging an engaging means through the aligned openings.

63. The method according to claim 62, wherein the openings are aligned in a manner such that the front and rear sides of the towel do not come into direct contact with each other after arranging of the engaging means through the openings.
